(19) United States
(12) Patent Application Publication
(10) Pub. No.: US 2020/0359597 A1
(43) Pub. Date: Nov. 19, 2020

(54) Multiple Outlet Animal Feeder

(71) Applicant: Antonia Hassan, HUNTSVILLE, AL (US)

(72) Inventor: Antonia Hassan, HUNTSVILLE, AL (US)

(21) Appl. No.: 16/871,450

(22) Filed: May 11, 2020

Related U.S. Application Data
(60) Provisional application No. 62/848,679, filed on May 16, 2019.

(51) Int. Cl. A01K 5/02; B62B 1/18

(52) U.S. Cl. CPC A01K 5/0266; B62B 1/18

(57) ABSTRACT

A multiple outlet animal feeder is provided. The multiple outlet animal feeder has a hollow housing which defines an interior volume that can store animal feed. At least one handle is located on a rear portion of the housing and at least one wheel is located on a bottom portion of the housing. A plurality of apertures is located through an upper surface of the housing and individual retractable tubular arms are connected to corresponding apertures of the plurality of apertures. A conveyor system is located within the interior volume and can transport a portion of the animal feed through the plurality of apertures and the plurality of tubular arms. A filling aperture is located on the housing in communication with the interior volume and can be used to fill the interior volume with animal feed.

### CROSS REFERENCE TO RELATED APPLICATIONS

This application claims the benefit of U.S. Provisional Application No. 62/848,679 filed on May 16, 2019. The above identified patent application is herein incorporated by reference in its entirety to provide continuity of disclosure.

### BACKGROUND OF THE INVENTION

The present invention relates to animal feeding systems. More particularly, the present invention provides for a multiple outlet animal feeder that can be utilized to provide animal feed to multiple animals and/or feed dishes quickly and easily.

Many people work on farms, animal shelters, and the like. The animals in these locations are typically fed multiple times a day, and all at the same time. Feeding these animals requires large amounts of feed being distributed at the same time. Feeding multiple animals in a shelter or on a farm several times a day can be immensely difficult due to the sheer number of animals involved. Traditionally, feed comes in large containers such as bags. Some bags can weigh upwards of 40 or 50 pounds, while others can weigh far more. Some shelters may have dozens of animals, while some farms may have hundreds, all that that need to be fed at once. In some cases, the animals require individual attention and serving sizes tailored to their needs. Typically, an employee must manually gather the feed and distribute it, placing a large amount of physical stress on the employee's body. Therefore, it can take a considerable amount of time and effort to feed multiple animals at the same time.

Devices have been disclosed in the known art that relate to animal feeding systems. These include devices that have been patented and disclosed in patent application publications. However, the devices in the known art have several drawbacks. Some devices are not portable and require the animal to come to the device in order to be fed. Some devices work on timers and must be positioned before the scheduled time to distribute the feed. Other devices rely on complex communications between computer chips and software and must be preprogrammed.

The present invention substantially diverges in design elements from the known art and consequently it is clear that there is a need in the art for an improvement to existing animal feeding systems. In this regard the present invention substantially fulfills these needs.

### SUMMARY OF THE INVENTION

In view of the foregoing disadvantages inherent in the known types of animal feeding systems now present in the art, the present invention provides a multiple outlet animal feeder, wherein the multiple outlet animal feeder can be utilized to provide animal feed to multiple animals and/or feed dishes quickly and easily. The present multiple outlet animal feeder comprises a hollow housing which defines an interior volume that can store animal feed. At least one handle is located on a rear portion of the housing and at least one wheel is located on a bottom portion of the housing. A plurality of apertures is located through an upper surface of the housing and individual retractable tubular arms are connected to corresponding apertures of the plurality of apertures. A conveyor system is located within the interior volume and can transport a portion of the animal feed through the plurality of apertures and the plurality of tubular arms. A filling aperture is located on the housing in communication with the interior volume and can be used to fill the interior volume with animal feed.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a side perspective view of an embodiment of the multiple outlet animal feeder.

FIG. 2 shows a side view of an embodiment of the multiple outlet animal feeder, in use.

FIG. 3 shows a schematic of representative components in an embodiment of the multiple outlet animal feeder.

### DETAILED DESCRIPTION OF THE INVENTION

Reference is made herein to the attached drawings. Like reference numerals are used throughout the drawings to depict like or similar elements of the multiple outlet animal feeder. For the purposes of presenting a brief and clear description of the present invention, a preferred embodiment will be discussed as used for the multiple outlet animal feeder. The figures are intended for representative purposes only and should not be considered to be limiting in any respect.

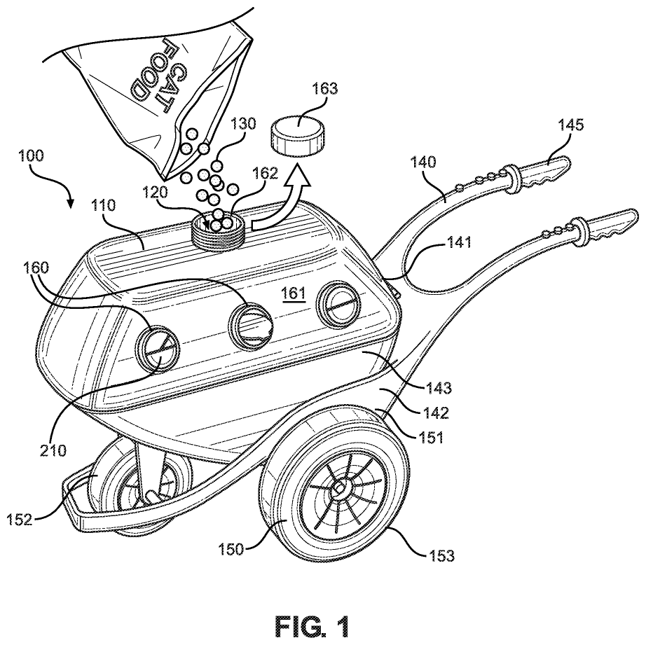

Referring now to FIG. 1, there is shown a side perspective view of an embodiment of the multiple outlet animal feeder. The multiple outlet animal feeder 100 comprises a hollow housing 110 defining an interior volume 120. The interior volume 120 is configured to store animal feed 130 therein. In the shown embodiment, the housing 110 includes a frame 142 onto which a storage compartment 143 rests. In such an embodiment, the storage compartment 143 is the hollow portion of the housing 110 and the frame 142 provides structure and stability to the device. Therefore, the frame 142 is configured to support the storage compartment 143 when the storage compartment 143 is full of animal feed 130. In various embodiments, the animal feed 130 can include solid pellets, plants, and other similar animal food products. It is therefore contemplated by this disclosure that the housing 110 is composed of a rugged and durable material such as steel, and that the interior surfaces of the hollow housing 110 are composed of materials that are safe to contact the animal feed 130 and other similar edible materials. The hollow housing 110 is also air-tight, with exception to various apertures and attachments as discussed below, such that the animal feed 130 stored therein will not spoil. It is further contemplated that the various apertures and attachments are configured to create airtight seals such that when they are closed, air will not pass into the interior volume 120 of the hollow housing 110.

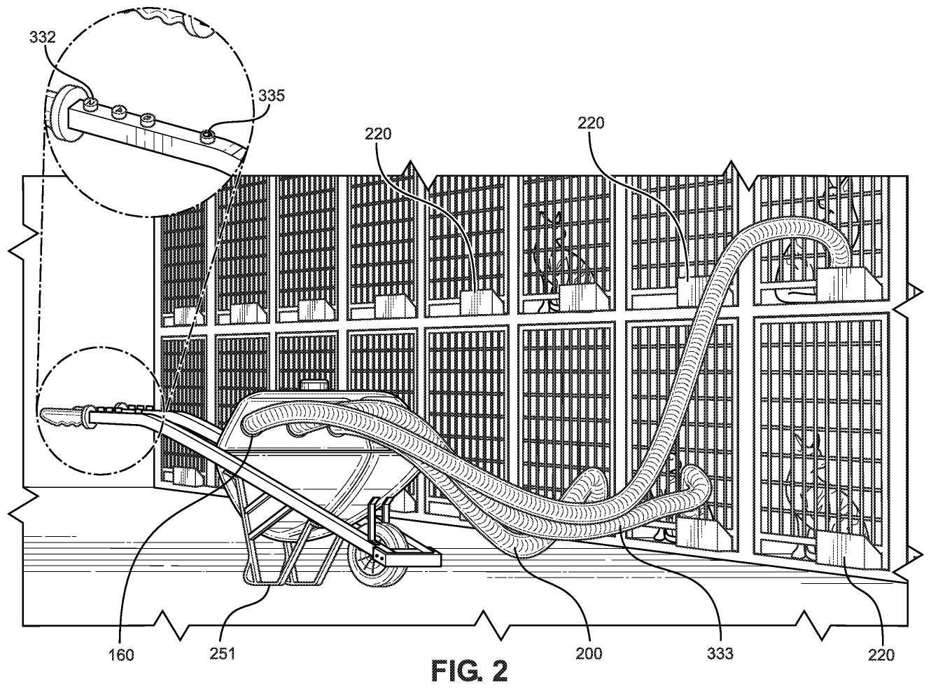

At least one wheel 150 is disposed on a bottom portion 151 of the housing 110. In the shown embodiment, three wheels 150 are disposed in a triangular pattern around the circumference of the housing 110. Further, in the shown embodiment, the forward wheel 152 is of a smaller diameter than the two back wheels 153. In such a configuration, the three wheels 150 provide added stability and maneuverability to the device when being moved from one place to another. In another embodiment, a single forward wheel 152 is disposed on the bottom portion 151 of the housing 110, and the housing 110 comprises at least one leg support (as shown in FIG. 2, 251). The leg supports are configured to provide a high-friction surface such that when the device rests on the leg supports, the device will not roll away. In such an embodiment, the at least one leg support replaces some of the wheels 150, sacrificing stability of the device when moving, for stability of the device when stationary.

At least one handle 140 is disposed on a rear portion 141 of the hollow housing 110. In the shown embodiment, a pair of handles 140 are disposed outwardly from the rear portion 141 of the hollow housing 110, roughly shoulder-width apart, and parallel to each other. In such an embodiment, the handles 140 are configured to enable a user to grasp one handle 140 with each of their hands and push the device, utilizing the wheels 150 to facilitate easy transport. The handles 140 also provide the user with the ability to alter the direction that the device travels by applying more pressure to one handle 140 than the other. In the shown embodiment, the handles 140 include hand grips 145 which provide added surface area for which the user's hands to grasp the handles 140. In a further embodiment, the hand grips 145 are ergonomic to provide additional comfort to the user when grasping the handles 140.

A plurality of apertures 160 are disposed through an upper surface 161 of the housing 110. The plurality of apertures 160 provide access to the interior volume 120 of the housing 110 and the animal feed 130 stored therein. A filling aperture 162 is disposed on the housing 110 in communication with the interior volume 120. An individual can add animal feed 130 to the interior volume 120 by pouring the animal feed 130 through the filling aperture 162. In one embodiment, a cap 163 is removably securable to the filling aperture 162. In a further embodiment, the cap 163 is threadably secured to the filling aperture 162, thereby forming an airtight seal. In another embodiment, the cap 163 is frictionally secured to the filling aperture 162. One of ordinary skill in the art will understand how an airtight seal can be formed through interaction between the cap 163 and the filling aperture 162, including through use of sealing materials, washers, gaskets, and the like.

Referring now to FIGS. 1 and 2, there are shown a side perspective view of an embodiment of the multiple outlet animal feeder, and a side view of an embodiment of the multiple outlet animal feeder, in use. A plurality of retractable tubular arms 200 are connected to the housing and the apertures 160. Each single retractable tubular arm 200 of the plurality of tubular arms 200 is connected to a single corresponding aperture 160 of the plurality of apertures 160. In this manner, each retractable tubular arm 200 is in communication with the interior volume via its own corresponding aperture 160. In the shown embodiment, the retractable tubular arms 200 are configured to collapse in an accordion-like manner into a storage configuration. In a further embodiment, the retractable tubular arms 200 are received within the interior volume of the housing when stored, and a distal end of the retractable tubular arm rests flush with the exterior of the housing.

In the embodiment shown in FIG. 1, each of the retractable tubular arms 200 are shown in a fully retracted configuration, and each of the retractable tubular arms 200 further comprise a vent 210 on a distal end thereof. Each vent 210 is configured to rotate between an open and a closed configuration. In this manner, a user can control which retractable tubular arms 200 provide a pathway to a desired location, such as a food bowl 220, and which can remain closed. In one embodiment, an airtight seal is formed when the vent 210 is in a closed configuration. In this manner, when the retractable tubular arm 200 is not being used, the vent 210 can be closed, and the interior volume of the housing will not be left open to access through the retractable tubular arm 200.

In use, the plurality of retractable tubular arms 200 can be extended and positioned as the user desires. For example, in the shown embodiment the retractable tubular arms 200 are positioned such that the distal ends thereof are in communication with food bowls 220. In this manner, animal feed can be delivered to various food bowls 220 of differing heights and locations at the same time. The user is also able to select which of the plurality of retractable tubular arms 200 to use at the same time. For example, where there are only three food bowls 220 that are to be filled, the user can extend and utilize three retractable tubular arms 200 and can keep the remaining three retractable tubular arms 200 in a stored position.

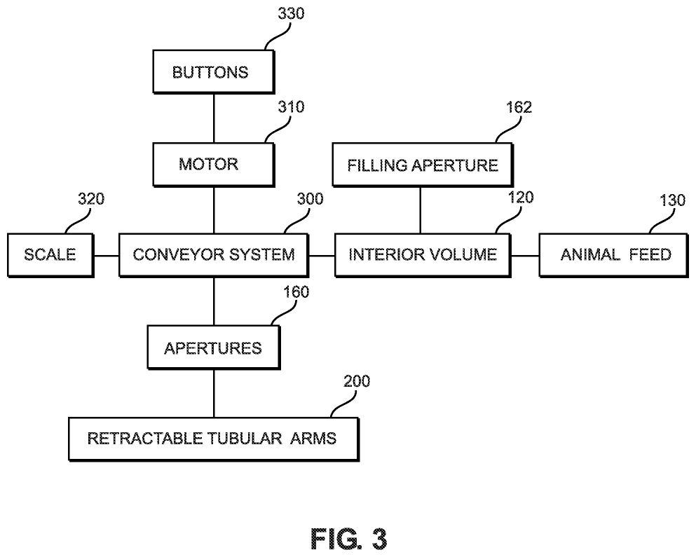

Referring now to FIGS. 2 and 3, there are shown a side view of an embodiment of the multiple outlet animal feeder, in use, and a schematic of representative components in an embodiment of the multiple outlet animal feeder. A conveyor system 300 is disposed in the interior volume 120 of the housing. The conveyor system 300 is configured to transport a portion of the animal feed 130 through the plurality of apertures 160 and the plurality of retractable tubular arms 200 into a desired area, such as a food bowl. A filling aperture 162 can be utilized to allow a user to pour animal feed 130 into the interior volume 120. In some embodiments, the conveyor system 300 is in operable connection with at least one motor 310. In further embodiments involving multiple motors 310, the conveyor system 300 can be utilized to provide animal feed 130 to a subset of the plurality of apertures 160 and the plurality of retractable tubular arms 200. In another embodiment, a scale 320 is in operable connection with the conveyor system 300. The scale 320 is configured to determine the amount of animal feed 130 on a section of the conveyor system 300. Once a pre-defined amount of animal feed 130 is detected on the conveyor system 300, via the scale 320, the conveyor system can transport the animal feed 130 to a desired aperture 160 and retractable tubular arm 200. One of ordinary skill in the art will understand how the scale 320, in concert with at least one motor 310 and a plurality of apertures 160 and retractable tubular arms 200 can provide pre-defined desired amounts of animal feed 130 to and through specific retractable tubular arms 200.

In a further embodiment, a plurality of buttons 330 are disposed on at least one handle. In some embodiments, the plurality of buttons 330 include a power button 335 and a series of retractable tubular arm buttons. In one such embodiment, the power button 335 is configured to actuate and de-actuate at least one motor 310. In various further embodiments, the power button 335 can be utilized to control a single motor 310, a subset of a plurality of motors 310, and all of the plurality of motors 310 at one time, according to the needs of the user. In one embodiment, the plurality of buttons 330 includes a plurality of retractable tubular arm buttons, wherein each of the plurality of retractable tubular arm buttons is configured to actuate at least one motor 310 and a portion of the conveyor system 300 to direct a flow of animal feed 130 from the interior volume through a corresponding aperture 160 and through a corresponding retractable tubular arm 200. For example, if a number two retractable tubular arm button (as shown on FIG. 2, 332) is depressed, the conveyor system 300 will dispense animal feed 130 through only the number two retractable tubular arm (as shown on FIG. 2, 333). In this manner a user can direct the conveyor system 300 to provide the animal feed 130 through a specific selected retractable tubular arm 200 only.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A multiple outlet animal feeder, comprising:
a hollow housing defining an interior volume;
wherein the interior volume is configured to store animal feed therein;
at least one handle disposed on a rear portion of the housing;
at least one wheel disposed on a bottom portion of the housing;
a plurality of apertures disposed through an upper surface of the housing;
a plurality of retractable tubular arms;
wherein each single retractable tubular arm of the plurality of retractable tubular arms is connected to a single corresponding aperture of the plurality of apertures;
a conveyor system disposed in the interior volume;
wherein the conveyor system is configured to transport a portion of the animal feed through the plurality of apertures and the plurality of retractable tubular arms; and
a filling aperture disposed on the housing in communication with the interior volume.

2) The multiple outlet animal feeder of claim 1, wherein the housing further comprises at least one leg support.

3) The multiple outlet animal feeder of claim 1, further comprising at least one motor in operable connection with the conveyor system.

4) The multiple outlet animal feeder of claim 1, wherein each of the plurality of retractable tubular arms comprises a vent on a distal end thereof.

5) The multiple outlet animal feeder of claim 4, wherein the vent rotates between an open and a closed configuration.

6) The multiple outlet animal feeder of claim 5, wherein an airtight seal is formed when the vent is in the closed configuration.

7) The multiple outlet animal feeder of claim 1, further comprising a scale in operable connection with the conveyor system.

8) The multiple outlet animal feeder of claim 1, further comprising a cap that is removably securable to the filling aperture.

9) The multiple outlet animal feeder of claim 8, wherein an airtight seal is formed when the cap is secured to the filling aperture.

10) A multiple outlet animal feeder, comprising:
a hollow housing defining an interior volume;
wherein the interior volume is configured to store animal feed therein;
at least one handle disposed on a rear portion of the housing;
a plurality of buttons disposed on the at least one handle;
at least one wheel disposed on a bottom portion of the housing;
a plurality of apertures disposed through an upper surface of the housing;
a plurality of retractable tubular arms;
wherein each single retractable tubular arm of the plurality of retractable tubular arms is connected to a single corresponding aperture of the plurality of apertures;
a conveyor system disposed in the interior volume;
wherein the conveyor system is configured to transport a portion of the animal feed through the plurality of apertures and the plurality of retractable tubular arms; and
a filling aperture disposed on the housing in communication with the interior volume.

11) The multiple outlet animal feeder of claim 10, wherein the housing further comprises at least one leg support.

12) The multiple outlet animal feeder of claim 10, further comprising at least one motor in operable connection with the conveyor system.

13) The multiple outlet animal feeder of claim 10, wherein each of the plurality of retractable tubular arms comprises a vent on a distal end thereof.

14) The multiple outlet animal feeder of claim 13, wherein the vent rotates between an open and a closed configuration.

15) The multiple outlet animal feeder of claim 14, wherein an airtight seal is formed when the vent is in the closed configuration.

16) The multiple outlet animal feeder of claim 1, further comprising a scale in operable connection with the conveyor system.

17) The multiple outlet animal feeder of claim 1, further comprising a cap that is removably securable to the filling aperture.

18) The multiple outlet animal feeder of claim 17, wherein an airtight seal is formed when the cap is secured to the filling aperture.

19) The multiple outlet animal feeder of claim 12, wherein the plurality of buttons includes a power button, wherein the power button is configured to actuate and de-actuate at least one motor.

20) The multiple outlet animal feeder of claim 12, wherein the plurality of buttons includes a plurality of retractable tubular arm buttons, wherein each of the plurality of retractable tubular arm buttons is configured to actuate at least one motor and a portion of the conveyor system to direct a flow of animal feed from the interior volume through a corresponding aperture and through a corresponding retractable tubular arm.
